(19) United States
(12) Patent Application Publication
(10) Pub. No.: US 2020/0166951 A1
(43) Pub. Date: May 28, 2020

(54) AUTONOMOUS DRIVING METHOD ADAPTED FOR RECOGNITION FAILURE OF ROAD LINE AND METHOD OF BUILDING DRIVING GUIDE DATA

(71) Applicant: ELECTRONICS AND TELECOMMUNICATIONS RESEARCH INSTITUTE, Daejeon (KR)

(72) Inventor: Doo Seop CHOI, Sejong-si (KR)

(21) Appl. No.: 16/684,898

(22) Filed: Nov. 15, 2019

(30) Foreign Application Priority Data
Nov. 28, 2018 (KR) 10-2018-0149212

(51) Int. Cl. G05D 1/02; G05D 1/00; G06K 9/00; B60W 40/06

(52) U.S. Cl. CPC G05D 1/0285; G05D 1/0278; G05D 1/0212; G05D 2201/0213; G06K 9/00798; G06K 9/00805; B60W 40/06; G05D 1/0088

(57) ABSTRACT

An autonomous driving method includes (a) setting a global driving plan of determining a plurality of global node points for which at least one driving route change of a left turn, a right turn, or a U-turn to a destination is needed and establishing a driving plan for a route change at each of the global node points; (b) recognizing road lines and nearby obstacles and performing autonomous driving using information of the recognized road lines and nearby obstacles; and (c) when recognition of the information of the road lines fails, receiving driving guide data of a road segment ahead from the outside through wireless communication, recognizing nearby obstacles, and performing autonomous driving on the road segment in consideration of the driving guide data and information of the recognized nearby obstacle.

### CROSS-REFERENCE TO RELATED APPLICATION

This application claims priority to and the benefit of Korean Patent Application No. 10-2018-0149212, filed on Nov. 28, 2018, the disclosure of which is incorporated herein by reference in its entirety.

### BACKGROUND

### 1. Field of the Invention

The present disclosure relates to an autonomous driving technique.

### 2. Discussion of Related Art

The following description is merely intended to provide background information related to embodiments set forth herein and does not form the prior art.

Recently, research has been actively conducted on autonomous driving. For autonomous driving, it is necessary to accurately recognize an external environment using sensors or the like and determine driving conditions, such as a driving direction and speed, based on information obtained by the recognition of the external environment.

Radar and the like are used as the sensors for recognizing the external environment but use of a vision sensor is becoming vigorous so as to recognize more information. The vision sensor is relatively inexpensive compared to other types of sensors and thus has gained much attraction.

In this regard, technology for recognizing an external environment of a vehicle by pattern recognition or image processing is being greatly developed and is expected to be greatly helpful for autonomous driving.

For autonomous driving, it is basically necessary to recognize road lines using a sensor. The road lines should be recognized to drive thereby and drive safely within a current lane.

When the road lines cannot be recognized due to variables such as weather or road conditions, autonomous driving is difficult to carry out and thus countermeasures against unexpected situations should be taken.

### SUMMARY OF THE INVENTION

The present disclosure is directed to providing an autonomous driving technique for conducting autonomous driving even when recognition of road lines fails.

According to an aspect of the present disclosure, there is provided an autonomous driving method adapted to a failure of recognition of road lines which is capable of recognizing road lines and nearby obstacles and performing autonomous driving along the recognized road lines in consideration of the recognized nearby obstacles, the autonomous driving method including (a) setting a global driving plan of determining a plurality of global node points for which at least one driving route change of a left turn, a right turn, or a U-turn to a destination is needed and establishing a driving plan for a route change at each of the global node points; (b) recognizing road lines and nearby obstacles and performing autonomous driving using information of the recognized road lines and nearby obstacles; and (c) when recognition of the information of the road lines fails, receiving driving guide data of a road segment ahead from the outside through wireless communication, recognizing nearby obstacles, and performing autonomous driving on the road segment in consideration of the driving guide data and information of the recognized nearby obstacle.

In at least one embodiment of the present disclosure, the driving guide data may include a plurality of local node points on the road segment ahead, and direction vector information of each of the plurality of local node points.

The driving guide data may be obtained from driving trajectory data of other vehicles driving on the road segment.

The driving trajectory data of the other vehicles may include at least one of Global Positioning System (GPS) accuracy, a destination, vehicle information, or surrounding environment information.

The driving trajectory data of the other vehicles may further include a plurality of pieces of driving data of a plurality of vehicles, and the autonomous driving method may further include selecting one of the plurality of pieces of driving data.

The selecting of one of the plurality of pieces of driving data may be performed in consideration of at least one of a plurality of variables, including whether the driving trajectory data is driving trajectory data of a vehicle closest to a current position of a subject vehicle, whether a driving trajectory is most stable driving trajectory, whether the destination is identical to a destination of the subject vehicle, whether the GPS accuracy is high, whether the vehicle type is similar to a vehicle type of the subject vehicle, and whether weather information included in the surrounding environment information indicates a clear day.

The selecting of one of the plurality of pieces of driving data may be performed by evaluating scores in consideration of the plurality of variables with respect to the other vehicles and determining priorities according to the scores.

In at least one embodiment of the present disclosure, the autonomous driving method may further include receiving the driving trajectory data from the other vehicles driving on the road segment via a remote server through wireless communication, and storing the received data.

In at least one embodiment of the present disclosure, the local node points and the direction vector information may be determined based on road shape information of the road segment.

In at least one embodiment of the present disclosure, (b) or (c) may include calculating an evaluation value of a result of the recognition of the road lines and comparing the evaluation value with a reference value to determine whether the recognition of the road lines fails.

According to another aspect of the present disclosure, there is provided a method of building autonomous driving vehicle guide data by recognizing road lines and nearby obstacles and building, in a server, driving guide data to be transmitted to an autonomous driving vehicle which drives along the recognized road lines in consideration of the recognized nearby obstacles, the method including collecting driving trajectory data of a vehicle driving on a certain road segment by transmitting the driving trajectory data to a server from the vehicle; and storing the driving trajectory data in the server as driving guide data of the road segment.

Here, the driving trajectory data may include information of a plurality of locations on a driving trajectory on the road segment, and driving direction vectors of the respective locations.

The driving trajectory data may further include at least one of driving stability, a destination, vehicle type, weather, or GPS accuracy.

In at least one embodiment of the present disclosure, the storing of the driving guide data may include performing data updating on the basis of evaluation values of the received driving trajectory data and previously stored driving trajectory data of other vehicles, the evaluation values being obtained using an evaluation algorithm.

The driving trajectory data may include information of locations on a driving trajectory of a corresponding vehicle on the road segment and a driving direction vector at each of the locations and further include at least one piece of information of driving stability, a destination, a vehicle type, weather, or GPS accuracy. The evaluation values may be calculated on the basis of the GPS accuracy or the driving stability.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1A through FIG. 1C are flowcharts of an autonomous driving method according to an embodiment of the present disclosure;

FIG. 2 illustrates a global driving route plan of FIG. 1A through FIG. 1C;

FIG. 3 is a conceptual diagram of a process of performing block A of FIG. 2;

FIG. 4 is a conceptual diagram of a case in which driving guide data is received in a plurality of sets in the process of performing the block A of FIG. 2;

FIG. 5 is a diagram for explaining a process of collecting driving guide data; and

FIG. 6 is a view illustrating an example of a computer system in which a method according to an embodiment of the present invention is performed.

### DETAILED DESCRIPTION OF EXEMPLARY EMBODIMENTS

Exemplary embodiments of the present disclosure will be described in detail below with reference to the accompanying drawings. While the present disclosure is shown and described in connection with exemplary embodiments thereof, it will be apparent to those skilled in the art that various modifications can be made without departing from the spirit and scope of the present disclosure.

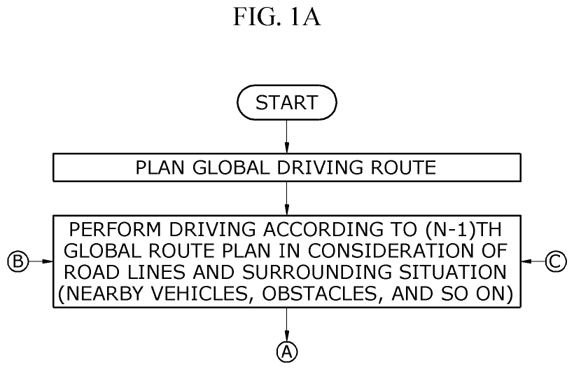

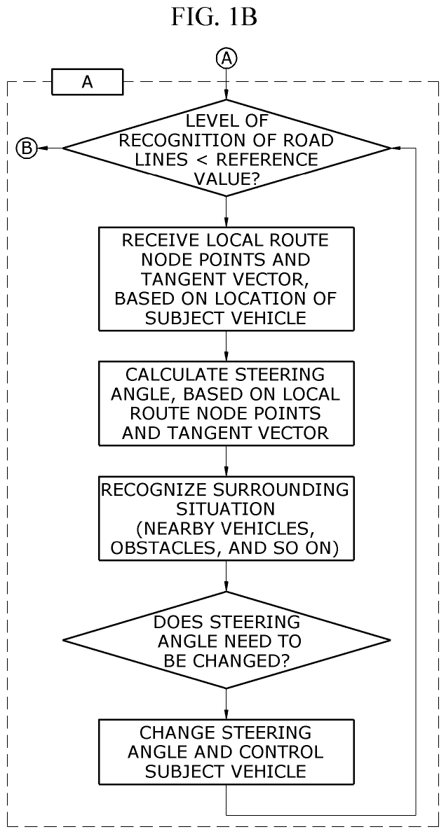

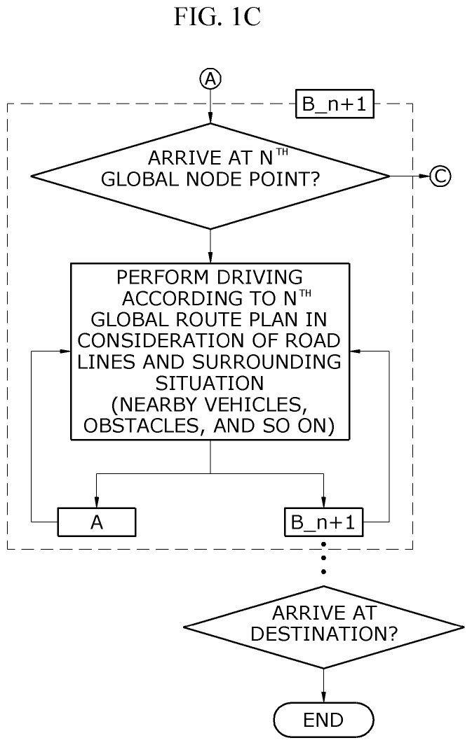

An autonomous driving method according to one embodiment of the present disclosure will be described with reference to FIGS. 1 to 3 below.

First, when a destination is input or commanded, a global driving route to the destination is planned.

The planning of the global driving route is performed by recognizing global node points at which a change of a driving route, such as a left turn and a right turn, is necessary and determining a route change plan at the global node points. In at least one embodiment, a global node point may be set to correspond to a junction, such as an intersection, of the road.

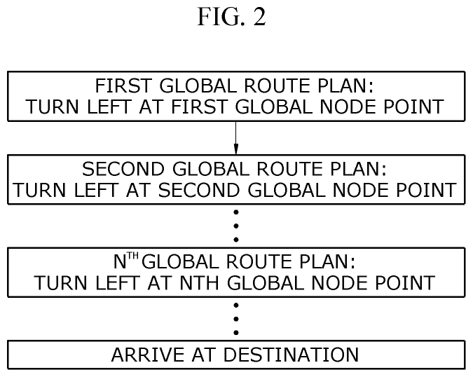

As illustrated in FIG. 2, in a global driving route plan, driving route plans at global node points necessary to reach a destination are set by, for example, determining a first global route plan to turn left at a first global node point and a second global route plan to turn left at the second global node point.

Such a global driving route plan may be the same as or similar to a route plan of a navigation device of a related art.

As a concrete example, the global driving route plan may be as follows:
(1^{st} global route plan) Turn left at Crossroad ○○○ and go straight 3 km on a second lane
(2^{nd} global route plan) Turn left at Crossroad xxx and go straight 10 km
. . .
Arrive at a destination

After the global driving route plan is set, driving is performed on sections between the global node points. In this case, obstacles such as nearby vehicles and road line information are recognized and autonomous driving is performed using the information obtained by a result of the recognition. For example, the road line information may be recognized using an image sensor and the obstacles may be recognized by Light Detection And Ranging (LiDAR), radar, an image sensor, etc. only or in combination. In one autonomous driving method, road lines of a current driving lane are recognized and driving is performed within a distance set by the road lines.

For example, driving is performed from an (n−1)^{th} global node point to an n^{th} global node point according to an (n−1)^{th} global route plan. After the n^{th} global node point is reached, driving is performed to an (n+1)^{th} global node point according to an n^{th} global route plan. Autonomous driving is completed by repeating this process until arriving at the destination.

In the performing of autonomous driving, a failure of recognition of a road line may occur as will be described with reference to block A of FIG. 1A through FIG. 1C below.

First, a level of road line recognition is evaluated. When an evaluation value is less than or equal to a reference value, it may be determined that driving using the road line information is not suitable.

When the road line recognition fails as described above, driving guide data is received by requesting a remote server to provide the driving guide data.

In order to request the driving guide data, location-related information of a current autonomous vehicle is transmitted to the remote server.

Here, the location-related information may be a current location of the vehicle.

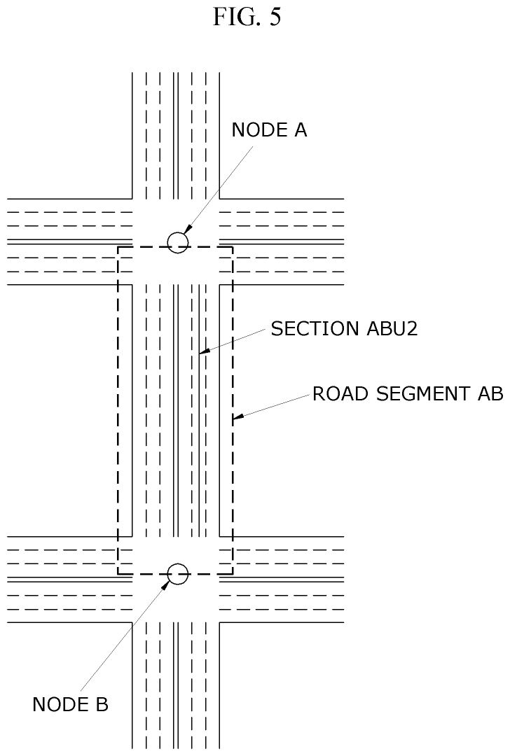

Alternatively, the location related information may represent an entire section of a corresponding road including the current location of the vehicle. That is, information regarding a section of ooo road including the current location may be transmitted. For example, a section number of the section of the road may be transmitted to the server, as will be described with reference to FIG. 5 below.

The server quickly transmits driving guide data corresponding to the section of the road to the vehicle requesting the driving guide data.

The driving guide data is information regarding a plurality of local route node points, including direction vector information, of the section of the road.

As such, when the information regarding the local node points and direction vector information at the local node points are received, the autonomous driving vehicle drives on the section of the road while considering obstacle recognition information, such as nearby vehicles, using the driving guide data instead of road lines.

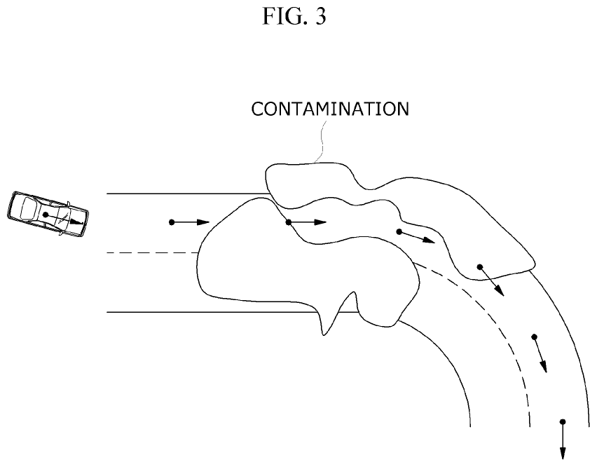

FIG. 3 schematically shows autonomous driving in a situation in which performing road line recognition is difficult.

That is, when road lines of the road are covered with contamination and thus cannot be recognized, autonomous driving is performed by receiving, as the driving guide data, the information regarding the local node points and the direction vector information at the local node points from the server.

The driving guide data may be data obtained based on a shape of the road. For example, the driving guide data may include information regarding the local node points of the section of the road and tangent vectors of the road at the local node points. The local node points may be node points on a specific lane of the road. Therefore, the driving guide data is provided in units of lanes such as a first lane and a second lane, and driving guide data for a specific lane among the lanes may be received from the server. A vehicle requesting data may transmit information regarding a lane on which the vehicle is currently driving when requesting the data.

Alternatively, the driving guide data may be data obtained from driving trajectories of other vehicles that have previously driven on a corresponding section of the road. That is, data may be generated and built using location information (a local node point) and driving-direction vector information (e.g., yaw rate information) transmitted at regular time or distance intervals to the server from another vehicle driving on the section of the road in the past.

In this case, the driving guide data may additionally include at least one of stability information of a driving trajectory, a destination, Global Positioning System (GPS) accuracy, a vehicle type, or relevant weather information.

In this case, the stability information of the driving trajectory may be a rate of change of a yaw rate of the vehicle or information based on the rate of change of the yaw rate. The relevant weather information is preferably weather information of a region through which the vehicle has driven.

The driving guide data may include a plurality of data sets based on a plurality of vehicles rather than on the trajectory of a single vehicle.

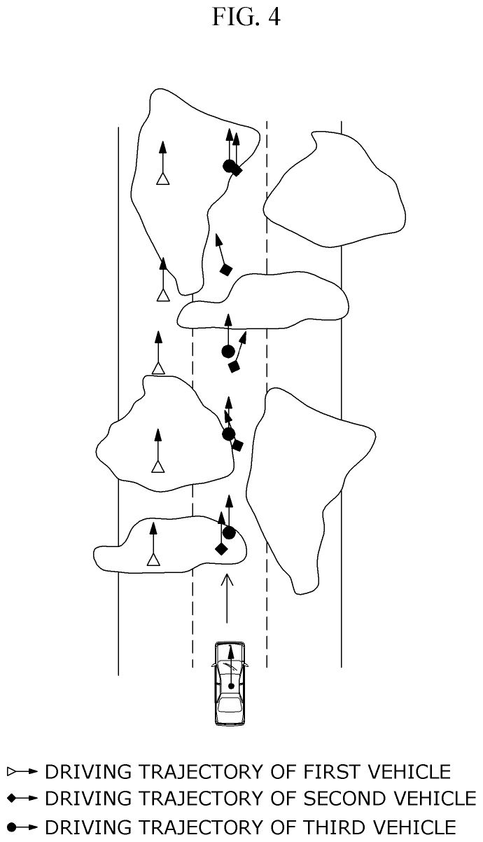

That is, as illustrated in FIG. 4, the driving guide data may include driving guide data of the plurality of vehicles, such as driving guide data of a first vehicle, driving guide data of a second vehicle, and driving guide data of a third vehicle.

A certain evaluation algorithm may be performed to select data most suitable for a current subject vehicle among the driving guide data of the plurality of vehicles.

Preferably, an evaluation value of driving guide data of each vehicle is calculated by the following equation:

score=f(x1, x2, x3, x4, x5, x6)

Here, x1 represents a distance between the subject vehicle and a local node point closest thereto according to the driving guide data, x2 represents driving stability information, x3 represents a similarity between a current destination of the subject vehicle and the destination included in the driving guide data, x4 represents GPS accuracy, x5 represents a similarity between vehicle types, and x6 represents weather information.

In a situation of FIG. 4, the subject vehicle which is autonomously driving receives the driving guide data based on driving trajectory of the first vehicle, the driving guide data based on driving trajectory of the second vehicle, and the driving guide data based on driving trajectory of the third vehicle, calculates evaluation values of the driving guide data of these vehicles using the above equation, and selects most suitable driving guide data on the basis of the evaluation values.

For example, when the evaluation value of the driving guide data based on the driving trajectory of the first vehicle is score1, the evaluation value of the driving guide data based on the driving trajectory of the second vehicle is score2, and the driving guide data based on the driving trajectory of the third vehicle is score 3, the driving guide data based on the driving trajectory of the third vehicle is selected as most suitable data and used for autonomous driving when the score3 is a highest value.

A method of generating driving guide data and providing the same to a server will be described with reference to FIG. 5 below.

First, related terms may be defined as follows:
node A: one node point which is a global or local node point in a road segment AB;
node B: another node point which is a global or local node point in the road segment AB;
U: direction of a driving lane of the road;
D: direction of an opposite lane of the road; and
1, 2, 3, . . . : number of each of driving lanes

According to the definition above, ‘section ABU2’ represents a second lane among driving lanes of a road segment AB.

The above definition is merely provided to explain collecting driving guide data and thus the present disclosure is not limited thereby.

While a vehicle is driving on a road segment AB, the vehicle transmits road segment information thereof (e.g., section information defined as above, i.e., the section ABU2) to the server, together with driving trajectory data thereof (a plurality of local node points in the driving trajectory and a direction vector at each of the node points), driving stability data (e.g., a yaw rate change rate or speed, etc.), a destination, a vehicle type, weather information while driving, GPS accuracy information, and the like. Here, the road segment information may not be transmitted from the vehicle to the server but be determined by the server by receiving driving trajectory information.

The server may continuously collect and store data transmitted thereto and prepare a plurality of driving guide data sets with respect to a corresponding road segment.

In this case, an updating process may be provided such that only a set amount of data set may be stored. That is, previously stored data may be updated with data having an evaluation value better than that of the previously stored data by evaluating received driving trajectory data using a certain evaluation algorithm.

The evaluation of the received driving trajectory data is performed, for example, using GPS accuracy, driving stability information, a degree of data utilization (e.g., a frequency of use of the received driving trajectory as driving guide data of another vehicle), and the like.

Preferably, currently received driving trajectory data and previously stored data are evaluated using GPS accuracy and driving stability information, degrees of availability of data evaluated as having evaluation values lower than that of the currently received driving trajectory data are evaluated to select data to be deleted, and the data to be deleted is updated with the currently received driving trajectory data.

According to the present disclosure, autonomous driving can be performed even when recognition of road lines fails due to road pollution, damage, or weather conditions.

It will be apparent to those skilled in the art that various modifications can be made to the above-described exemplary embodiments of the present disclosure without departing from the spirit or scope of the present disclosure. Thus, it is intended that the present disclosure covers all such modifications as long as the modifications are within the scope of the appended claims and their equivalents.

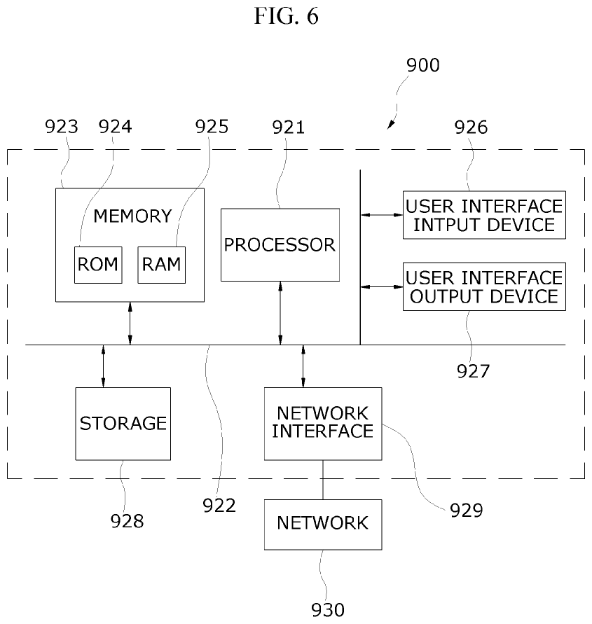

The method according to an embodiment of the present invention may be implemented in a computer system or may be recorded in a recording medium. FIG. 6 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922. Also, the computer system may further include a network interface 929 coupled to a network. The processor 921 may be a central processing unit (CPU) or a semiconductor device that processes a command stored in the memory 923 and/or the storage 928. The memory 923 and the storage 928 may include various types of volatile or non-volatile storage mediums. For example, the memory 923 may include a ROM 924 and a RAM 925. Thus, the method according to an embodiment of the present invention may be implemented as a method that can be executable in the computer system. When the method according to an embodiment of the present invention is performed in the computer system, computer-readable commands may perform the producing method according to the present invention.

What is claimed is:

1. An autonomous driving method adapted to a failure of recognition of road lines which is capable of recognizing road lines and nearby obstacles and performing autonomous driving along the recognized road lines in consideration of the recognized nearby obstacles, the autonomous driving method comprising:
(a) setting a global driving plan of determining a plurality of global node points for which at least one driving route change of a left turn, a right turn, or a U-turn to a destination is needed, and establishing a driving plan for a route change at each of the global node points;
(b) recognizing road lines and nearby obstacles and performing autonomous driving using information of the recognized road lines and nearby obstacles; and
(c) when recognition of the information of the road lines fails, receiving driving guide data of a road segment ahead from the outside through wireless communication, recognizing nearby obstacles, and performing autonomous driving on the road segment in consideration of the driving guide data and information of the recognized nearby obstacle.

2. The autonomous driving method of claim 1, wherein, in (c), the driving guide data comprises:
a plurality of local node points on the road segment ahead; and
direction vector information of each of the plurality of local node points.

3. The autonomous driving method of claim 2, wherein the driving guide data is obtained from driving trajectory data of other vehicles driving on the road segment.

4. The autonomous driving method of claim 3, wherein the driving trajectory data of the other vehicles comprises at least one of Global Positioning System (GPS) accuracy, a destination, vehicle information, or surrounding environment information.

5. The autonomous driving method of claim 4, wherein the driving trajectory data of the other vehicles further comprises a plurality of pieces of driving data of a plurality of vehicles, and
the autonomous driving method further comprises selecting one of the plurality of pieces of driving data.

6. The autonomous driving method of claim 5, wherein the selecting of one of the plurality of pieces of driving data is performed in consideration of at least one of a plurality of variables,
wherein the plurality of variables comprise:
whether the driving trajectory data is driving trajectory data of a vehicle closest to a current position of a subject vehicle;
whether a driving trajectory is most stable driving trajectory;
whether the destination is identical to a destination of the subject vehicle;
whether the GPS accuracy is high;
whether the vehicle type is similar to a vehicle type of the subject vehicle; and
whether weather information included in the surrounding environment information indicates a clear day.

7. The autonomous driving method of claim 6, wherein the selecting of one of the plurality of pieces of driving data is performed by evaluating scores in consideration of the plurality of variables with respect to the other vehicles and determining priorities according to the scores.

8. The autonomous driving method of claim 2, wherein the local node points and the direction vector information are determined based on road shape information of the road segment.

9. The autonomous driving method of claim 3, further comprising receiving the driving trajectory data from the other vehicles driving on the road segment via a remote server through wireless communication, and storing the received data.

10. The autonomous driving method of claim 1, wherein operation (b) or (c) comprises calculating an evaluation value of a result of the recognition of the road line and comparing the evaluation value with a reference value to determine whether the recognition of the road line fails.

11. A method of building autonomous driving vehicle guide data by recognizing road lines and nearby obstacles and building, in a server, driving guide data to be transmitted to an autonomous driving vehicle which drives along the recognized road lines in consideration of the recognized nearby obstacles, the method comprising:
collecting driving trajectory data of a vehicle driving on a certain road segment by transmitting the driving trajectory data to a server from the vehicle; and
storing the driving trajectory data in the server as driving guide data of the road segment.

12. The method of claim 11, wherein the driving trajectory data comprises:
information of a plurality of locations on a driving trajectory on the road segment; and
driving direction vectors of the respective locations.

13. The method of claim 12, wherein the driving trajectory data further comprises at least one of driving stability, a destination, a vehicle type, weather, or and Global Positioning System (GPS) accuracy.

14. The method of claim 11, wherein the storing of the driving guide data comprises performing data updating on the basis of evaluation values of the received driving trajectory data and previously stored driving trajectory data of another vehicle, the evaluation values being obtained using an evaluation algorithm.

15. The method of claim 14, wherein the driving trajectory data comprises information of locations on a driving trajectory of a corresponding vehicle on the road segment and a driving direction vector at each of the locations and further comprises at least one piece of information of driving stability, a destination, a vehicle type, weather, or Global Positioning System (GPS) accuracy,
wherein the evaluation values are calculated on the basis of the GPS accuracy or the driving stability.
